(19) United States
(12) Patent Application Publication
(10) Pub. No.: US 2012/0002249 A1
(43) Pub. Date: Jan. 5, 2012

(54) IMAGE SCANNING APPARATUS TO ALTERNATE SCANNING AND METHOD THEREOF

(75) Inventor: Cheoul-young KIM, Suwon-si (KR)

(73) Assignee: Samsung Electronics Co., Ltd., Suwon-si (KR)

(21) Appl. No.: 13/232,137

(22) Filed: Sep. 14, 2011

(30) Foreign Application Priority Data
Jan. 25, 2010 (KR) 2011-0007410
Sep. 16, 2010 (KR) 2010-0091022

(51) Int. Cl. H04N 1/04

(52) U.S. Cl. 358/475

(57) ABSTRACT

An image scanning apparatus including a plurality of scanning units which are disposed in positions which correspond to each other across the moving path of the scanning object, a user interface to receive input of a scanning command, a supply unit to make a scanning object to pass the scanning units, a controlling unit to control the plurality of scanning units to scan the scanning object alternately when the scanning object passes the plurality of scanning units, and a storage unit to store each image scanned in the plurality of scanning units.

### CROSS-REFERENCE TO RELATED APPLICATIONS

This application claims benefit of priority under 35 U.S.C. §119(a) to Korean Patent Application Nos. 2010-91022 and 2011-0007410, filed in the Korean Intellectual Property Office on Sep. 16, 2010 and Jan. 25, 2011, respectively, the disclosures of which are incorporated herein by reference in their entirety.

### BACKGROUND

1. Field of the Invention

The present general inventive concept generally relates an image scanning apparatus and an image scanning method, and more specifically, an image scanning apparatus and an image scanning method wherein a plurality of scanning units scan a script alternately, thereby improving the scanning quality.

2. Description of the Related Art

An image scanning apparatus is an apparatus which scans an original image such as a document, a picture or a film, and converts the scanned image into digital data. The digital data may be shown on a computer monitor or printed out by a printer and be generated as an output image. Such an image scanning apparatus may be a scanner, copier, facsimile, or an MFP (Multi Function Peripheral) where the functions of a scanner, copier and facsimile are all integrated in one apparatus.

Recent image scanning apparatuses having scanning functions such as those of scanners, facsimiles and digital copiers comprise an ADF (Auto Document Feeder) for scanning consecutive scripts. In addition, it is a recent trend for image scanning apparatuses to have a DADF (Dual Auto Document Feeder) comprising a plurality of scanning units so as to automatically scan both surfaces of a script being fed.

In such a two-surface scanning system, it is advantageous for the two scanning units to be disposed close to each other to efficiently scan both surfaces of the script being fed. More specifically, disposing the two scanning units close to each other reduces the range of the moving section of the script, thereby increasing the scanning speed and minimizing the size of the structure of the scanner to save material expenses. Furthermore, in the two surface scanning system, it is easier to secure a length of a flat section required to prevent trembling of a script in the image scanning section.

On the other hand, disposing the two scanning units close to each other also intensifies the backside see-through phenomenon due to illumination by the plurality of scanning units. More specifically, there is a problem that in the case where two image sensor units are disposed close to each other, if the two scanning units operate at the same time, the backside see-through phenomenon could occur where the backside of the script is projected on the other image sensor due to illumination by the counterpart scanning unit.

### SUMMARY

The present general inventive concept provides an image scanning apparatus and an image scanning method which make a plurality of scanning units scan a script alternately, so as to improve the scanning quality.

Additional aspects and utilities of the present general inventive concept will be set forth in part in the description which follows and, in part, will be obvious from the description, or may be learned by practice of the present general inventive concept.

The foregoing and/or other features and utilities of the present general inventive concept may be realized by an image scanning apparatus including a plurality of scanning units disposed in positions which correspond to each other across a moving path of a scanning object, a user interface unit to receive a scanning command, a supply unit to make the scanning object pass the plurality of scanning units when the scanning command is input, a controlling unit to control the plurality of scanning units to scan the scanning object alternately when the scanning object passes between the plurality of scanning units, and a storage unit to store each image scanned in the plurality of scanning units. Each of the plurality of scanning units uses an LED (Light Emitting Diode) as a light source.

The scanning units may include an illuminating unit to irradiate light to the scanning object, a sensor unit to scan image information of the scanning object from the light reflected from the scanning object, and a lens unit which is disposed between the scanning object and the sensor unit, and directs the light reflected from the scanning object to the sensor unit.

The illuminating unit may operate in synchronization with an operation clock pulse of the sensor unit.

The controlling unit may control an operation clock pulse of each of the plurality of scanning units to have twice a frequency compared to when the plurality of scanning units do not alternately scan the scanning object.

The controller may control the plurality of scanning units to scan an area twice as large per an operation clock pulse compared to when the plurality of scanning units do not alternately scan the scanning object.

The controller may use an image scanned during the scanning operation as an image that is not stored.

The illuminating unit may operate on/off according to a PWM (Pulse Width Modulation) method to irradiate light of a predetermined radiation intensity to the scanning object when the scanning unit is operating.

When at least one scanning unit of the plurality of scanning units is operating, the controlling unit may control the at least one operating scanning unit to irradiate a light of a predetermined radiation intensity to the scanning object and the remaining scanning units to irradiate a light of less that the predetermined radiation intensity to the scanning object.

When at least one scanning unit of the plurality of scanning units is operating, the controlling unit may control the remaining scanning units to not irradiate la light to the scanning object.

The controlling unit may control the remaining scanning units to irradiate a light of half or less of the predetermined radiation intensity to the scanning object.

The scanning object may be a script.

The image scanning apparatus may further include a sensing unit to sense a weight of the script, wherein when the sensed weight of the script is a predetermined weight or greater, the controlling unit may control the plurality of scanning units to scan the script simultaneously.

The plurality of scanning units may include a first scanning unit to scan a first surface of the script, and a second scanning unit disposed opposite to the first scanning unit and to scan a second surface of the script.

The first scanning unit may be a CCD (Charge-Coupled Device), and the second scanning unit may be a CIS (Contact Image Sensor).

The controlling unit may control an illumination of the second scanning unit to be darker than an illumination of the first scanning unit when the first scanning unit is scan operating and control the illumination of the first scanning unit to be darker than the illumination of the second scanning unit when the second scanning unit is scan operating.

The controlling unit may control an illumination of the second scanning unit to be off when the first scanning unit is scan operating and may control an illumination of the first scanning unit to be off when the second scanning unit is scan operating.

The scanning object may be a 3-dimensional object, and the plurality of scanning units may be disposed in polygonal forms.

The foregoing and/or other features and utilities of the present general inventive concept may be realized by an image scanning method in an image scanning apparatus including receiving an input of a scanning command, passing a scanning object by a plurality of scanning units, scanning the scanning object by alternately using the plurality of scanning units, and storing each image scanned by the plurality of scanning units, and each of the plurality of scanning units uses an LED as a light source.

When at least one scanning unit of the plurality of scanning units is operating, the scanning may control the at least one operating scanning unit to irradiate a light of a predetermined radiation intensity to the scanning object and the remaining scanning units to irradiate a light of less than the predetermined radiation intensity to the scanning object and then scans the scanning object.

When at least one scanning unit of the plurality of scanning units is operating, the scanning may control the remaining scanning units not to irradiate a light to the scanning object and then scans the scanning object.

The scanning may control the remaining scanning units to irradiate a light of half or less of the predetermined radiation intensity to the scanning object.

The scanning may be twice as fast compared to when the plurality of scanning units are not alternately used.

The scanning may scan an area twice as large per the operation clock pulse compared to when the plurality of scanning units are not alternately used.

The scanning unit may use an image scanned during the scanning operation as an image that is not stored.

The scanning object may be a script.

The image scanning method in an image scanning apparatus may further include sensing a weight of the script; and when the sensed weight of the script is a predetermined weight or greater, the scanning scans the script by simultaneously using the plurality of scanning units.

The plurality of scanning units may include a first scanning unit and a second scanning unit disposed opposite each other and the scanning may include scanning a first surface of the object by using the first scanning unit and scanning a second surface of the object by using the second scanning unit.

The scanning may control an illumination of the second scanning unit to be darker than an illumination of the first scanning unit when the first scanning unit is scan operating and may control the illumination of the first scanning unit to be darker than the illumination of the second scanning unit when the second scanning unit is scan operating.

The scanning may control an illumination of the second scanning unit to be off when the first scanning unit is scan operating, and may control an illumination of the first scanning unit to be off when the second scanning unit is scan operating.

The foregoing and/or other features and utilities of the present general inventive concept may be realized by an image scanning apparatus including a first scanning unit disposed on a first side of a scanning path to scan a first surface of an object, a second scanning unit disposed on a second side of a scanning path to scan a second surface of the object, and a control unit to control the first scanning unit not to operate when the second scanning unit scans the second surface of the object and the second scanning unit not to operate when the first scanning unit scans the first surface of the object.

The first and second scanning units may each include an illuminating unit to generate a light having a predetermined intensity when the control unit controls the respective scanning unit to operate.

The control unit may control the illuminating unit to generate a light having less than the predetermined intensity when the control unit controls the respective scanning unit not to operate.

The control unit may control the illuminating unit not to generate a light when the control unit controls the respective scanning unit not to operate.

The first scanning unit and the second scanning unit may be disposed a predetermined distance apart along the scanning path.

The first scanning unit and the second scanning unit may be disposed opposite to each other.

The image scanning apparatus may include a weight sensing unit to sense a weight of the object, an the control unit may control the first scanning unit and second scanning unit to operate simultaneously when the sensed weight of the object is greater than a predetermined weight.

The foregoing and/or other features and utilities of the present general inventive concept may be realized by an image scanning method including scanning a first surface of an object by using a first scanning unit, scanning a second surface of the object by using a second scanning unit, and controlling the first scanning unit not to operate when scanning the second surface of the object and controlling the first scanning unit not to operate when scanning the first surface of the object.

The foregoing and/or other features and utilities of the present general inventive concept may be realized by a computer-readable recording medium having embodied thereon a computer program to execute a method, wherein the method includes scanning a first surface of an object by using a first scanning unit, scanning a second surface of the object by using a second scanning unit, and controlling the first scanning unit not to operate when scanning the second surface of the object and controlling the first scanning unit not to operate when scanning the first surface of the object.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 is a block diagram of a configuration of an image scanning apparatus according to an exemplary embodiment of the present general inventive concept;

FIG. 2 illustrates an image scanning apparatus according to an exemplary embodiment of the present general inventive concept;

FIG. 3 illustrates configurations of a first scanning unit and a second scanning unit according to an exemplary embodiment of the present general inventive concept;

FIGS. 4A and 4B illustrate a first scanning unit and a second scanning unit according to an exemplary embodiment of the present general inventive concept;

FIG. 5 illustrates a disposition of the first scanning unit and the second scanning unit according to an exemplary embodiment of the present general inventive concept;

FIG. 6 illustrates characteristics of a paper; and

FIG. 7 is a flow chart explaining an image scanning method according to an exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

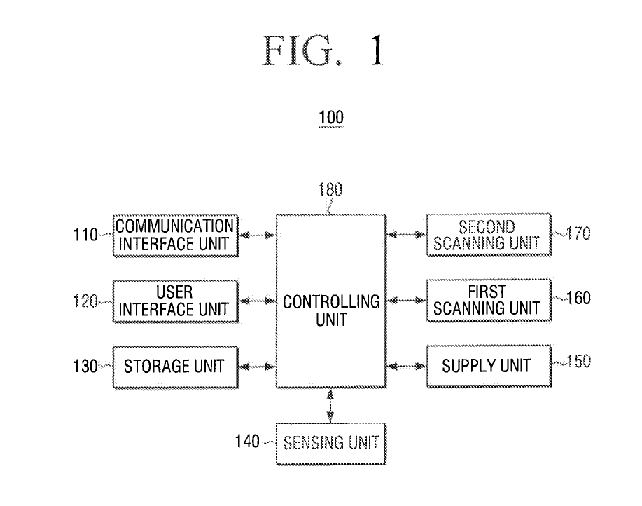

FIG. 1 is a block diagram illustrating an image scanning apparatus according to an exemplary embodiment of the present general inventive concept. The image scanning apparatus 100 may be embodied as a scanner, copier, facsimile or an MFP (Multi Function Peripheral) where functions of a scanner, copier and facsimile are integrated in one apparatus, or a 3D scanner.

With reference to FIG. 1, the image scanning apparatus 100 includes a communication interface unit 110, a user interface unit 120, a storage unit 130, a sensing unit 140, a supply unit 150, a first scanning unit 160, a second scanning unit 170, and a controlling unit 180.

The communication interface unit 110 is connected to a terminal device (not illustrated) such as a PC, notebook PC, PDA, and digital camera, and may transmit an image scanned in the image scanning apparatus 100 to the terminal device. More specifically, the communication interface unit 110 is formed to connect the image scanning apparatus 100 to an external device. The communication interface unit 110 may connect the image scanning apparatus 100 to the external device through a LAN (Local Area Network), the internet, a USB (Universal Serial Bus) port, or other communication interfaces.

The user interface unit 120 receives a scanning command from a user. In addition, the user interface unit 120 comprises a plurality of function keys which enable the user to set or select various functions supported by the image scanning apparatus 100 and displays various information provided from the image scanning apparatus 100. The user interface unit 120 may be a device such as a touch pad where an input and an output may be realized at the same time, or a device of a combination of a mouse and a monitor.

Scanning commands may also be received from the terminal device through the communication interlace unit 100.

The storage unit 130 may store the scanned image. More specifically, the storage unit 130 may store the image scanned by the first scanning unit 160 and the second scanning unit 170. The storage unit 130 may be a storage medium inside the image scanning apparatus 100 or an external storage medium, for example a removable disk including a USB memory, a storage medium connected to the host, and a web server through a network.

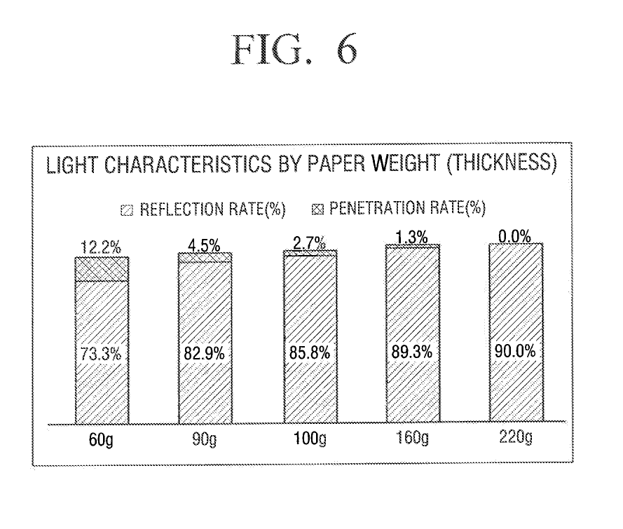

The sensing unit 140 senses a weight of a script. More specifically, in the case where the image scanning apparatus 100 is a scanner, copier, facsimile or an MFP (Multi Function Peripheral), the sensing unit 140 may measure a resistance value of the script provided from the supply unit 150 and sense the weight of the script. More specific operations of the sensing unit 140 will be explained later with reference to FIG. 6.

The supply unit 150 enables a scanning object to pass the plurality of scanning units. More specifically, when a scanning command of the user is input through the user interface unit 120 or the communication interface unit 110, the supply unit 150 enables the scanning object to pass the plurality of scanning units.

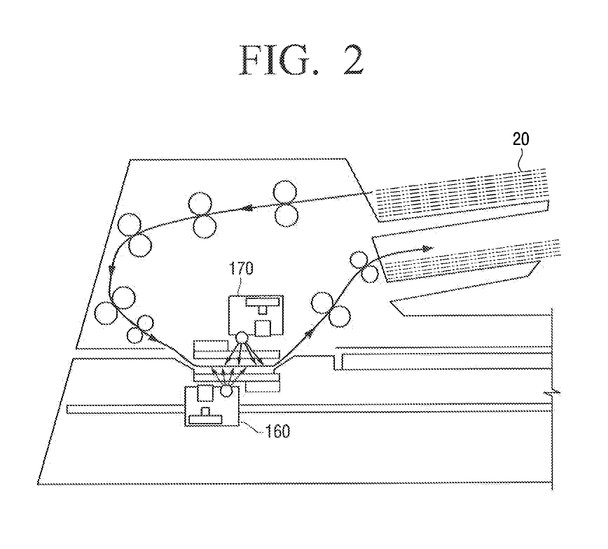

The scanning object may be a plane object such as a script, or a 3-dimensional object. More specifically, in the case where the scanning object is a plane object such as a script (that is, when the image scanning apparatus 100 is a scanner, copier, facsimile or an MFP which scans scripts), the supply unit 150 may move the script between the plurality of scanning units. Such operations of the supply unit 150 will be explained in greater detail hereinafter with reference to FIG. 2.

Meanwhile, in the case where the scanning object is a 3-dimensional object that is, when the image scanning apparatus 100 is a 3D scanner which scans 3-dimensional objects), the supply unit 150 may move the plurality of scanning units which are disposed in polygonal forms (for example, a regular triangle or a square) so that the 3-dimensional object can pass the plurality of scanning units.

The first scanning unit 160 and the second scanning unit 170 are disposed in positions which correspond to each other across the moving path of the scanning object.

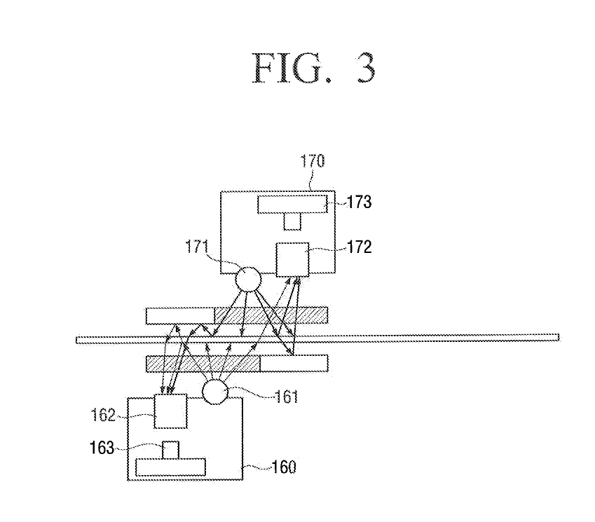

The first scanning unit 160 is disposed on a flatbed, and may scan a first surface of the script fed in a DADF (Dual Auto Document Feeder). The first scanning unit 160 may be a CCD (Charge-Coupled Device). More specific configuration and operations of the first scanning unit 160 will be explained hereinafter with reference to FIG. 3.

The second scanning unit 170 is installed inside the DADF (Dual Auto Document Feeder), and may scan a second surface which is on the opposite side of the script scanned in the first scanning unit 160. The second scanning unit 160 may be a CIS (Contact Image Sensor). More specific configuration and operations of the second scanning unit will be explained hereinafter with reference to FIG. 3.

The controlling unit 180 controls each configurative element in the image scanning apparatus 100. More specifically, when a scanning command (or copying command) is input through the communication interface unit 110 or the user interface unit 120, the controlling unit 180 may control the supply unit 150 so that a scanning object can pass the plurality of scanning units.

In addition, when the scanning object goes through the plurality of scanning units, the controlling unit 180 controls the plurality of scanning units to alternately scan the scanning object. More specifically, when at least one scanning unit of the plurality of scanning units is operating, the controlling unit 180 may control so that the illumination of the remaining scanning units go below a predetermined radiation intensity or so that the illumination of the remaining scanning units goes off. The predetermined radiation intensity may be below the level that would cause the backside see-through phenomenon. For example, the controlling unit 180 may control such that the illumination of the remaining scanning units is half or less of the radiation intensity of when the scanning unit is in operation. The radiation intensity refers to the amount of light the illumination (that is, the luminous body) emits.

For example, in the case of scanning a script using the first scanning unit 160 and the second scanning unit 170, the controlling unit 180 may control the first scanning unit 160 and the second scanning unit 170 to scan the script alternately. More specifically, during the scanning operation of the first scanning unit 160, the controlling unit 180 may control so that the illumination of the second scanning unit 170 is darker than that of the first scanning unit 160, or that the illumination of the second scanning unit 170 goes off. Furthermore, during the scanning operation of the second scanning unit 170, the controlling unit 180 may control so that the illumination of the first scanning unit 160 is darker than that of the second scanning unit 170, or the illumination of the first scanning unit 160 goes off.

The controlling unit 180 which controls the plurality of scanning units to alternately scan the scanning object can operate twice as fast as a case when the plurality of scanning units do not alternately scan the scanning object. Specifically, if the plurality of scanning units alternately operate, the scanning time of the image scanning apparatus 100 can be reduced to half of a case when the scanning units do not alternately operate. Accordingly, the controlling unit 180 can control the scanning units to operate twice as fast as a case when the plurality of scanning units do not alternately scan the scanning object. More specifically, the controlling unit 180 can increase the scanning speed by increasing the frequency of an operation clock to twice the frequency of an operation clock when each the scanning units that does not alternately operate, or the controlling unit 180 can increase the target DPI to scan twice as large of an area compared to the scanning area when the scanning units are not alternately operated.

In addition, the controlling unit 180 may perform an image processing on the image scanned by the first scanning unit 160 and the second scanning unit 170, and may store the scanned image which has been image-processed in the storage unit 130.

In explaining FIG. 1, although exemplary embodiments using the first scanning unit 160 and the second scanning unit 170 were illustrated and explained, it is possible to embody an image scanning apparatus using three or more scanning units.

The image scanning apparatus 100 according to the aforementioned exemplary embodiment of the present disclosure is capable of reducing the radiation intensity of the illumination of the other scanning unit when one scanning unit is on scanning operation, by reducing the illumination of the scanning unit, thereby reducing the backside see-through phenomenon of the script and improving the quality of the scanned image.

FIG. 2 illustrates an image scanning apparatus according to an exemplary embodiment of the present general inventive concept.

More specifically, in the case where the image scanning apparatus 100 is a scanner, copier, facsimile or MFP (Multi Function Peripheral), as illustrated in FIG. 2, the supply unit 150 uses a plurality of rollers to move the scripts 20 accumulated in a feeding tray one by one between the plurality of scanning units.

In addition, when the scripts pass between the plurality of scanning units, the first scanning unit 160 may scan a first surface of the scripts 20 and the second scanning unit 170 may scan a second surface of the scripts 20.

FIG. 3 illustrates the configuration of the first scanning unit 160 and the second scanning unit 170 according to an exemplary embodiment of the present general inventive concept.

With reference to FIG. 3, the first scanning unit 160 is disposed in a position distanced to a left side from a vertical direction of the second scanning unit 170, and scans the first surface of a script fed from the DADF. More specifically, the first scanning unit 160 may comprise an illuminating unit 161, a lens unit 162, and a sensor unit 163.

The illumination unit 161 irradiates light to a script. More specifically, the illuminating unit 161 may irradiate light of a predetermined radiation intensity to a first surface of the script according to an operation clock pulse of the sensor unit 163. For example, the illuminating unit 161 may operate in synchronization with the operation clock pulse of the sensor unit 163. Also, the illuminating unit 161 may be delayed by a predetermined time from the operation clock pulse of the sensor unit 163 before operating. The illuminating unit may have a lighting time range of about 50%-150% of the interval of the operation clock pulse. The illuminating unit 161 may operate on/off according to a PWM (Pulse Width Modulation) method to irradiate light of a predetermined radiation intensity to the first surface of the script. When the second scanning unit 170 is operating, the controlling unit 180 may control the illuminating unit 161 of the first scanning unit 160 to irradiate light of half or less of the predetermined radiation intensity or to not irradiate light at all.

The illuminating unit 161 may be realized as light source such as a LED (Light-Emitting Diode) or AMOLED (Active Matrix Organic Light-Emitting Diode). More specifically, in the case where the illuminating unit 161 is operating according to the PWM (Pulse Width Modulation) method (that is, when high speed switching of the illuminating unit 161 is required), an LED or AMOLED, which are capable of high speed switching, may be used as the illuminating unit 161. On the other hand, when the high speed switching is not required, a CCFL (Cold Cathode Fluorescent Lamp), which is a general light source, may be used as the illuminating unit 161.

The lens unit 162 is disposed between the scanning object and the sensor unit 163, and directs the light irradiated from the scanning object to the sensor unit 163.

The sensor unit 163 scans the image information of the scanning object from the light which has been reflected from the scanning object and directed through the lens unit 162. The sensor unit 163 may be a CCD. Specifically, when the image information of the object to be scanned is alternately scanned, the sensor unit 163 can operate twice as fast as a case when the object is not alternately scanned. For example, the sensor unit 163 can operate twice as fast of a scanning speed by using an operation clock pulse having twice as high of a frequency compared to an operation clock pulse when the object is not alternately scanned. Alternatively, the sensor unit 163 can operate at twice as fast of a scanning speed by using a target DPI which is twice as large as a target DPI when the object is not alternately scanned, thus scanning an area twice as large per operation clock pulse compared to when the object is not alternately scanned.

The second scanning unit 170 is disposed in a position distanced to a right side from a vertical direction of the first scanning unit 170, and scans a second surface of the script fed from the DADF. In addition, the second scanning unit comprises an illuminating unit 171, a lens unit 172 and a sensor unit 173.

The illuminating unit 171 irradiates light to the second surface of the script. The illuminating unit 171 of the second scanning unit 170 operates similar to the illuminating unit 161 of the first scanning unit 160 except that when the first scanning unit 170 is operating, the controlling unit 180 may control the illuminating unit 171 of the second scanning unit 170 to irradiate light of half or less of the predetermined radiation intensity or to not irradiate light at all.

The lens unit 172 is disposed between the scanning object and the sensor unit 173, and directs the light irradiated from the scanning object on the sensor unit 173.

The sensor unit 173 scans the image information of the scanning object from the light which has been directed through the lens unit 172. The sensor unit 163 may be embodied as a CIS. Specifically, when the image information of the object to be scanned is alternately scanned, the sensor unit 163 can operate twice as fast as a case when the object is not alternately scanned. For example, the sensor unit 163 can operate at twice as fast of a scanning speed by using an operation clock pulse having twice as high of a frequency compared to an operation clock pulse when the object is not alternately scanned. Alternatively, the sensor unit 163 can operate at twice as fast of a scanning speed by using a target DPI which is twice as large as a target DPI when the object is not alternately scanned, thus scanning an area twice as large per operation clock pulse compared to when the object is not alternately scanned.

As described above, the image scanning apparatus 100 according to an exemplary embodiment of the present general inventive concept controls each of the scanning units to operate at twice the speed compared to when the scanning units do not alternately operate, thereby preventing a scanning speed slowdown of the image scanning apparatus 100.

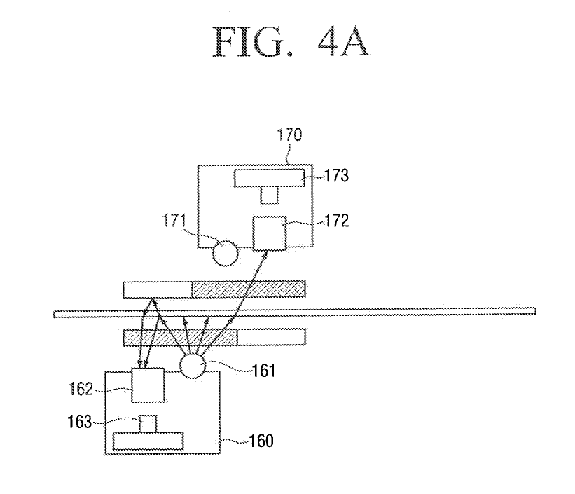

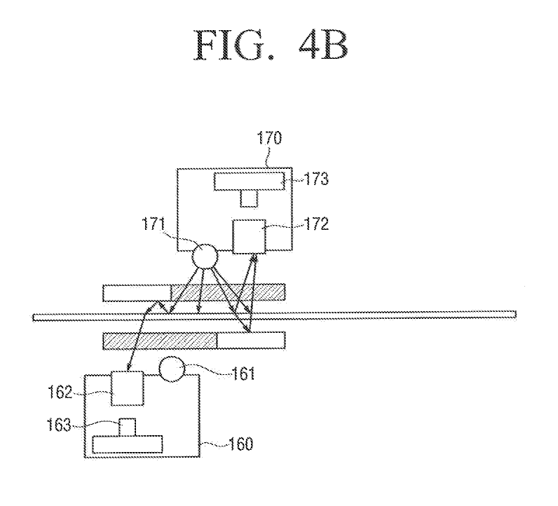

Operations of the first scanning unit 160 and the second scanning unit 170 will be explained in greater detail hereinafter with reference to FIGS. 4A and 4B.

With reference to FIG. 4A, when the first scanning unit 160 operates, the second scanning unit 170 does not operate. More specifically, the illuminating unit 161 of the first scanning unit 160 irradiates light to the first surface of the script. When the first surface of the script is irradiated to the first surface, the light is directed to the sensor unit 163 through the lens unit 162.

The light irradiated by the illuminating unit 161 of the first scanning unit 160 may pass through the script and reach the sensor unit 173 of the second scanning unit 170, but since the second scanning unit 170 is not operating at this time, the backside see-through phenomenon of the script does not have an effect on the second scanning unit 170.

In addition, when the first scanning unit 160 is operating, since the illuminating unit 171 of the second scanning unit 170 goes off, or only the light of a radiation intensity which would not cause the backside see-through phenomenon is irradiated, the sensor unit 163 of the first scanning unit 160 scans only the reflected light which has been irradiated by the illuminating unit 161 of the first scanning unit 160.

Next, when the second scanning unit 170 operates as in FIG. 4B, the illuminating unit 161 of the first scanning unit 160 does not operate.

Therefore, the light irradiated in the illuminating unit 171 of the second scanning unit 170 may pass through the script as illustrated and reach the sensor unit 163 of the first scanning unit 160, but the sensor unit 163 of the first scanning unit 160 is not operating at this time, and thus the backside see-through phenomenon of the script does not have an effect on the first scanning unit 160.

In addition, when the second scanning unit 170 operates, the illuminating unit 161 of the first scanning unit 160 goes off or only the light of radiation intensity which would not cause the backside see-through phenomenon is irradiated, and thus the sensor unit 173 of the second scanning unit 170 scans only the reflected light which has been irradiated by the illuminating unit 171 of the second scanning unit 170.

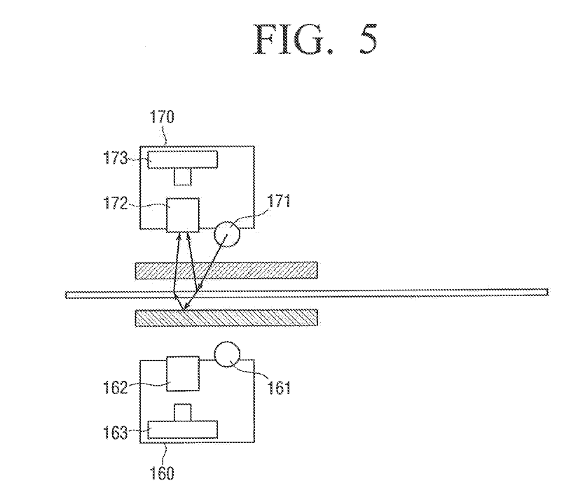

FIG. 5 illustrates the disposition of the first scanning unit 160 and the second scanning unit 170 according to another exemplary embodiment.

With reference to FIG. 5, the configuration of the first scanning unit 160 and that of the second scanning unit 170 are the same as in FIG. 3. However, unlike in FIG. 3, the first scanning unit 160 and the second scanning unit 170 are disposed opposite to each other in a vertical direction.

In the past, as illustrated above, when a first scanning unit 160 and a second scanning unit 170 were disposed to be vertical to each other, the possibility that the light of the illuminating unit 161 of the first scanning unit 160 may reach the sensor unit 173 of the second scanning unit 170 increased, thus causing excessive backside see-through phenomenon.

In the present exemplary embodiment however, when the first scanning unit 160 is operating, the illuminating unit 171 of the second scanning unit 170 either does not operate or irradiates low radiation intensity, and thus the sensor unit 163 of the first scanning unit 160 only scans the reflected light which has been irradiated by the illuminating unit 161 of the first scanning unit 160.

On the other hand, when the second scanning unit 170 is operating, the illuminating unit 161 of the first scanning unit 160 does not operate or irradiates only light of radiation intensity which could not pass the script, and thus the sensor unit 173 of the second scanning unit 170 scans only the reflected light which has been irradiated by the illuminating unit 171 of the second scanning unit 170.

FIG. 6 illustrates a chart showing characteristics of paper by a weight of the paper

With reference to FIG. 6, when the weight of the paper is light (or the paper is thin), the penetration rate of the light increases. On the other hand, when the weight of the paper is heavy (or the paper is thick), the penetrating rate of the light decreases.

For example, when the script weighs 220 g or more, the light penetration rate is 0%, and thus the backside see-through phenomenon would not occur. Therefore, the sensing unit 140 may sense whether or not the weight of the input script is above a predetermined weight (for example, 220 g), and when a paper weighing the predetermined weight or more is input, the controlling unit 180 may control so that an alternated scanning operation is not performed. On the other hand, when a paper weighing the predetermined weight or more is input, the controlling unit 180 may control so that an alternated scanning operation is performed.

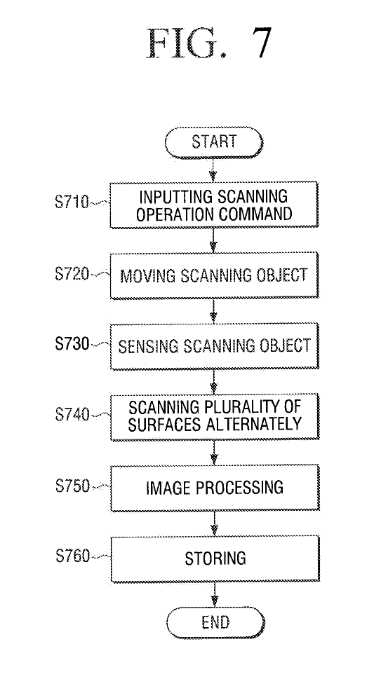

FIG. 7 is the flow chart illustrating an image scanning method according to an exemplary embodiment of the present disclosure.

First, a scanning operation command (or a scanning command or a copying command) is received (S710), and the scanning object is made to pass a plurality of scanning units (S720). The scanning object may be flat such as a script or may be 3-dimensional. More specifically, when the scanning object is a plane object such as a script, the script may be moved to pass the plurality of scanning units. On the other hand, when the scanning object is a 3-dimensional object, the plurality of scanning units may be moved so that the 3-dimensional object could pass the plurality of scanning units.

Next, a weight of the scanning object is sensed (S730). More specifically, when the scanning object is a script, a weight of the script is sensed by measuring a resistance of the script, and if the weight of the sensed paper is less that a predetermined weight, an operation explained hereinafter may be performed. On the other hand, if the weight of the sensed paper is the predetermined weight or above, the plurality of scanning units may be controlled to operate at the same time. This weight sensing operation may be omitted as well.

Next, the plurality of scanning units are used to scan the scanning object alternately (S740). More specifically, when at least one scanning unit of the plurality of scanning units operates, the illumination of the radiation intensity of the remaining scanning units may be controlled to be below a predetermined radiation intensity, or the illumination of the remaining scanning units may be controlled to go off. The predetermined radiation intensity may be a half of the radiation intensity of that of the operating scanning unit. At this time, each of the scanning units can operate twice as fast as a case when the scanning units do not alternately scan.

More specifically, in the case of scanning the script using two scanning units, the illumination of the second scanning unit may be controlled to be darker than the illumination of the first scanning unit or may be controlled to go off when the first scanning unit is scan operating, or the illumination of the first scanning unit may be controlled to be darker than the illumination of the second scanning unit or may be controlled to go off when the second scanning unit is scan operating.

In addition, an image processing may be performed on the scanned image (S750), and the image processed image may be stored (S760). Also, the image processed image may be transmitted to a predetermined terminal device without a separate storing operation.

According to the exemplary embodiments described above, when a scanning unit is operating, the image scanning method may reduce the illumination of the radiation intensity of the other scanning unit(s) or make the illumination of the radiation intensity of the other scanning unit(s) go off, thereby reducing the backside see-through phenomenon of the script and enhancing the quality of the scanned image. The image scanning method as in FIG. 7 can be implemented on the image scanning apparatus having the configuration of FIG. 1, and on other image scanning apparatuses having other configurations.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive have been shown and described, it would be appreciated by those skilled in the art that changes may be made in these embodiments without departing from the principles and spirit of the general inventive concept, the scope of which is defined in the claims and their equivalents.

What is claimed is:

1. An image scanning apparatus comprising;
a plurality of scanning units disposed in positions which correspond to each other across a moving path of a scanning object;
a user interface unit to receive a scanning command;
a supply unit to make the scanning object pass the plurality of scanning units when the scanning command is input;
a controlling unit to control the plurality of scanning units to scan the scanning object alternately when the scanning object passes between the plurality of scanning units; and
a storage unit to store each image scanned in the plurality of scanning units,
wherein each of the plurality of scanning units uses an LED (Light Emitting Diode) as a light source.

2. The image scanning apparatus according to claim 1, wherein each of the plurality of scanning units comprise;
an illuminating unit to irradiate light to the scanning object;
a sensor unit to scan image information of the scanning object from the light reflected from the scanning object; and
a lens unit disposed between the scanning object and the sensor unit, and to direct the light reflected from the scanning object to the sensor unit.

3. The image scanning apparatus according to claim 2, wherein the illuminating unit operates in synchronization with an operation clock pulse of the sensor unit.

4. The image scanning apparatus according to claim 3, wherein the controlling unit controls an operation clock pulse of each of the plurality of scanning units to have twice a frequency compared to when the plurality of scanning units do not alternately scan the scanning object.

5. The image scanning apparatus according to claim 3, wherein the controller controls the plurality of scanning units to scan an area twice as large per an operation clock pulse compared to when the plurality of scanning units do not alternately scan the scanning object.

6. The image scanning apparatus according to claim 5, wherein the controller uses an image scanned during the scanning operation as an image that is not stored.

7. The image scanning apparatus according to claim 2, wherein the illuminating unit operates on/off according to a PWM (Pulse Width Modulation) method to irradiate light of a predetermined radiation intensity to the scanning object when the scanning unit is operating.

8. The image scanning apparatus according to claim 1, wherein when at least one scanning unit of the plurality of scanning units is operating, the controlling unit controls the at least one operating scanning unit to irradiate a light of a predetermined radiation intensity to the scanning object and the remaining scanning units to irradiate a light of less than the predetermined radiation intensity to the scanning object.

9. The image scanning apparatus according to claim 8, wherein when at least one scanning unit of the plurality of scanning units is operating, the controlling unit controls the remaining scanning units to not irradiate a light to the scanning object.

10. The image scanning apparatus according to claim 8, wherein the controlling unit controls the remaining scanning units to irradiate a light of half or less of the predetermined radiation intensity to the scanning object.

11. The image scanning apparatus according to claim 1, wherein the scanning object is a script.

12. The image scanning apparatus according to claim 11, further comprising a sensing unit to sense a weight of the script,
wherein when the sensed weight of the script is a predetermined weight or greater, the controlling unit controls the plurality of scanning units to scan the script simultaneously.

13. The image scanning apparatus according to claim 11 wherein the plurality of scanning units comprise:
a first scanning unit to scan a first surface of the script; and
a second scanning unit disposed opposite to the first scanning unit and to scan a second surface of the script.

14. The image scanning apparatus according to claim 13, wherein the first scanning unit is a CCD (Charge-Coupled Device) and the second scanning unit is a CIS (Contact Image Sensor).

15. The image scanning apparatus according to claim 13, wherein the controlling unit controls an illumination of the second scanning unit to be darker than an illumination of the first scanning unit when the first scanning unit is scan operating and controls the illumination of the first scanning unit to be darker than the illumination of the second scanning unit when the second scanning unit is scan operating.

16. The image scanning apparatus according to claim 13, wherein the controlling unit controls an illumination of the second scanning unit to be off when the first scanning unit is scan operating and controls an illumination of the first scanning unit to be off when the second scanning unit is scan operating.

17. The image scanning apparatus according to claim 1, wherein the scanning object is a 3-dimensional object and the plurality of scanning units are disposed in polygonal forms.

18. An image scanning method in an image scanning apparatus the method comprising:
receiving an input of a scanning command;
passing a scanning object by a plurality of scanning units;
scanning the scanning object by alternately using the plurality of scanning units; and
storing each image scanned by the plurality of scanning units,
wherein each of the plurality of scanning units uses an LED (Light Emitting Diode) as a light source.

19. The image scanning method in an image scanning apparatus according to claim 18, wherein when at least one scanning unit of the plurality of scanning units is operating, the scanning controls the at least one operating scanning unit to irradiate a light of a predetermined radiation intensity to the scanning object and the remaining scanning units to irradiate a light of less than the predetermined radiation intensity to the scanning object and then scans the scanning object.

20. The image scanning method in an image scanning apparatus according to claim 19, wherein when at least one scanning unit of the plurality of scanning units is operating, the scanning controls the remaining scanning units to not irradiate a light to the scanning object and then scans the scanning object.

21. The image scanning method in an image scanning apparatus according to claim 19, wherein the scanning controls the remaining scanning units to irradiate a light of half or less of the predetermined radiation intensity to the scanning object

22. The image scanning method in an image scanning apparatus according to claim 18, wherein the scanning is twice as fast compared to when the plurality of scanning units are not alternately used.

23. The image scanning method in an image scanning apparatus according to claim 2, wherein the scanning scans an area twice as large per the operation clock pulse compared to when the plurality of scanning units are not alternately used.

24. The image scanning method in an image scanning apparatus according to claim 23, wherein the scanning unit uses an image scanned during the scanning operation as an image that is not stored.

25. The image scanning method in an image scanning apparatus according to claim 18, wherein the scanning object is a script.

26. The image scanning method in an image scanning apparatus according to claim 25, further comprising:
sensing a weight of the script; and
wherein when the sensed weight of the script is a predetermined weight or greater, the scanning scans the script by simultaneously using the plurality of scanning units.

27. The image scanning method in an image scanning apparatus according to claim 25, wherein the plurality of scanning units comprise a first scanning unit and a second scanning unit disposed opposite to each other and the scanning comprises:
scanning a first surface of the script by using the first scanning unit; and
scanning a second surface of the script by using the second scanning unit.

28. The image scanning method in an image scanning apparatus according to claim 27, wherein the scanning controls an illumination of the second scanning unit to be darker than an illumination of the first scanning unit when the first scanning unit is scan operating and controls the illumination of the first scanning unit to be darker than the illumination of the second scanning unit when the second scanning unit is scan operating.

29. The image scanning method in an image scanning apparatus according to claim 27, wherein the scanning controls an illumination of the second scanning unit to be off when the first scanning unit is scan operating and controls an illumination of the first scanning unit to be off when the second scanning unit is scan operating.

30. An image scanning apparatus comprising:
a first scanning unit disposed on a first side of a scanning path to scan a first surface of an object;
a second scanning unit disposed on a second side of a scanning path to scan a second surface of the object; and
a control unit to control the first scanning unit not to operate when the second scanning unit scans the second surface of the object and the second scanning unit not to operate when the first scanning unit scans the first surface of the object.

31. The image scanning apparatus according to claim 30, wherein the first and second scanning units each comprise:
an illuminating unit to generate a light having a predetermined intensity when the control unit controls the respective scanning unit to operate.

32. The image scanning apparatus according to claim 31, wherein the control unit controls the illuminating unit to generate a light having less than the predetermined intensity when the control unit controls the respective scanning unit not to operate.

33. The image scanning apparatus according to claim 31, wherein the control unit controls the illuminating unit not to generate a light when the control unit controls the respective scanning unit not to operate.

34. The image scanning apparatus according to claim 30, wherein the first scanning unit and the second scanning unit are disposed a predetermined distance apart along the scanning path.

35. The image scanning apparatus according to claim 30, wherein the first scanning unit and the second scanning unit are disposed opposite to each other.

36. The image scanning apparatus according to claim 30, further comprising:
a weight sensing unit to sense a weight of the object, wherein the control unit controls the first scanning unit and second scanning unit to operate simultaneously when the sensed weight of the object is greater than a predetermined weight.

37. An image scanning method comprising:
scanning a first surface of an object by using a first scanning unit;
scanning a second surface of the object by using a second scanning unit; and
controlling the first scanning unit not to operate when scanning the second surface of the object and controlling the first scanning unit not to operate when scanning the first surface of the object.

38. A non-transitory computer-readable recording medium having embodied thereon a computer program to execute a method, wherein the method comprises:
scanning a first surface of an object by using a first scanning unit;
scanning a second surface of the object by using a second scanning unit; and
controlling the first scanning unit not to operate when scanning the second surface of the object and controlling the first scanning unit not to operate when scanning the first surface of the object.
